(19) United States
(12) Patent Application Publication
(10) Pub. No.: US 2009/0029206 A1
(43) Pub. Date: Jan. 29, 2009

(54) ELECTROLYTE SOLUTION FOR HYDROGEN GENERATING APPARATUS AND HYDROGEN GENERATING APPARATUS COMPRISING THE SAME

(75) Inventors: Chang-Ryul Jung, Seoul (KR); Jae-Hyuk Jang, Seongnam-si (KR); Bosung Ku, Suwon-si (KR); Kyoung-Soo Chae, Suwon-si (KR); Arunabha Kundu, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/179,948

(22) Filed: Jul. 25, 2008

(30) Foreign Application Priority Data
Jul. 25, 2007 (KR) 10-2007-0074349

(51) Int. Cl. H01M 8/06; H01M 8/08; C25B 1/02

(52) U.S. Cl. 429/19; 429/46; 204/279

(57) ABSTRACT

One aspect of the invention provides an electrolyte solution for a hydrogen generating apparatus that includes water, at least one metal borohydride, at least one ionic compound, and at least one chelating agent, as well as a hydrogen generating apparatus that includes the electrolyte solution. With an electrolyte solution for a hydrogen generating apparatus based on an embodiment of the invention, it is possible to regulate the rate at which the hydrogen is generated and increase the amount and time of hydrogen generation.

### CROSS-REFERENCE TO RELATED APPLICATIONS

This application claims the benefit of Korean Patent Application No. 10-2007-0074349 filed with the Korean Intellectual Property Office on Jul. 25, 2007, the disclosure of which is incorporated herein by reference in its entirety.

### BACKGROUND

1. Technical Field

The present invention relates to an electrolyte solution for a hydrogen generating apparatus and a hydrogen generating apparatus including the electrolyte solution.

2. Description of the Related Art

A fuel cell is an apparatus which converts the energies of pure hydrogen or hydrogen contained in hydrocarbon-based substances such as methanol and natural gases, and oxygen in the air, directly into electrical energy by way of an electrochemical reaction.

FIG. 1 illustrates the basic operational principle of a fuel cell.

Referring to FIG. 1, a fuel cell 10 may include a fuel electrode 11 as an anode and an air electrode 13 as a cathode. The fuel electrode 11 receives molecular hydrogen (H₂), which is dissociated into hydrogen ions (H⁺) and electrons (e⁻). The hydrogen ions move past a membrane 12 towards the air electrode 13. This membrane 12 corresponds to an electrolyte layer. The electrons move through an external circuit 14 to generate an electric current. The hydrogen ions and the electrons combine with the oxygen in the air at the air electrode 13 to generate water. The fuel electrode 11 and the air electrode 13 are disposed with the electrolyte membrane in-between, to form a membrane electrode assembly (MEA). The following Reaction Scheme 1 represents the chemical reactions described above:

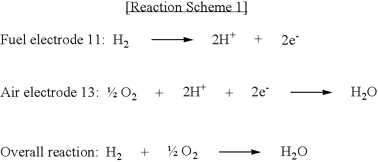

In short, the fuel cell 10 functions as a battery, since the electrons dissociated from the fuel electrode 11 generate a current, moving through the external circuit. Such a fuel cell 10 is a pollution-free power source, because it does not produce any noxious emissions such as SOx, NOx, etc., and produces only a little amount of carbon dioxide. Also, the fuel cell may offer several other advantages, such as low noise and little vibration, etc.

In order to obtain a high-performance fuel cell, hydrogen may be used as the fuel. In particular, a micro fuel cell may advantageously be applied as a power source in portable electronic devices, such as cell phones and laptop computers, etc. A type of fuel cell suitable for a micro fuel cell is the polymer electrolyte membrane fuel cell (PEMFC), which operates at relatively low temperatures and has a high output density, and which is the subject of active development efforts. In commercializing the fuel cell, an important task to be resolved beforehand lies in the technology of storing and supplying hydrogen.

If the micro fuel cell uses a hydrogen storage material directly, which has a high hydrogen-volume/weight ratio, the efficiency of hydrogen generation becomes very low. Thus, there is a need for developments in materials and technology with regards using the hydrogen storage material. Besides this, there may also be a method of compressing hydrogen and supplying to the micro fuel cell, but there are as yet no suitable materials or technology that allows the storage of hydrogen after compression.

To resolve the problems mentioned above, methods are being studied of installing a fuel processor at the front portion of a micro fuel cell. The fuel processor is an apparatus that reforms fuel, such as methanol and ethanol, etc., to generate hydrogen. However, fuel processor systems entail high reform temperatures, complicated systems, and additional power consumption. Moreover, the reformed gas may likely contain impurities (e.g. CO₂, CO, etc.) besides pure hydrogen.

Thus, the need is increasing for a hydrogen generating apparatus, which can resolve the problems in the method of generating hydrogen using the fuel processor and generate hydrogen efficiently.

### SUMMARY

An aspect of the invention is to provide an electrolyte solution for a hydrogen generating apparatus and a hydrogen generating apparatus including the electrolyte solution, with which pure hydrogen can be produced.

Another aspect of the invention is to provide a fuel cell system that utilizes the hydrogen generating apparatus.

One aspect of the invention provides an electrolyte solution for a hydrogen generating apparatus that includes water, at least one metal borohydride, at least one ionic compound, and at least one chelating agent.

In one embodiment of the invention, the metal borohydride may be selected from the group consisting of lithium borohydride, sodium borohydride, potassium borohydride, ammonium borohydride, tetramethyl ammonium borohydride, and mixtures thereof.

The concentration of the metal borohydride may be about 5 to about 50 weight % based on the total weight of the electrolyte solution.

The ionic compound may be selected from the group consisting of lithium chloride, potassium chloride, sodium chloride, calcium chloride, potassium nitrate, sodium nitrate, potassium sulfate, sodium sulfate, and mixtures thereof.

The concentration of the ionic compound may be about 5 to about 35 weight % based on the total weight of the electrolyte solution.

The chelating agent may be a carboxylate, and may be selected from the group consisting of potassium citrate, sodium citrate, sodium acetate, potassium acetate, ammonium acetate, and mixtures thereof.

The concentration of the chelating agent may be about 5 to about 30 weight % based on the total weight of the electrolyte solution.

In one embodiment of the invention, the electrolyte solution may further include alcohol, which in turn may be selected from the group consisting of ethylene glycol, glycerol, methanol, ethanol, butanol, propanol, and mixtures thereof.

The concentration of the alcohol may be about 2.5 to about 15 weight % based on the total weight of the electrolyte solution.

Another aspect of the invention provides a hydrogen generating apparatus that includes an electrolyzer, which contains an electrolyte solution of water, at least one metal borohydride, at least one ionic compound, and at least one chelating agent; a first metal electrode, which is positioned inside the electrolyzer and dipped in the electrolyte solution, and which is configured to generate electrons; and a second metal electrode, which is positioned inside the electrolyzer and dipped in the electrolyte solution, and which is configured to receive the electrons to generate hydrogen.

In one embodiment of the invention, the hydrogen generating apparatus may further include a switch positioned between the first electrode and the second electrode.

The hydrogen generating apparatus may be coupled to a fuel cell to supply hydrogen, and multiple first metal electrodes and second metal electrodes may be installed in the electrolyzer.

Yet another aspect of the invention provides a fuel cell system that includes the hydrogen generating apparatus mentioned above, and a membrane-electrode assembly (MEA) which receives the hydrogen generated by the hydrogen generating apparatus and converts the chemical energy of the hydrogen into electrical energy to produce a direct current.

As set forth in certain aspects of the invention, by using an electrolyte solution for a hydrogen generating apparatus, which includes at least one metal borohydride, at least one ionic compound, and at least one chelating agent, the rate of hydrogen generation can be regulated, and the amount of hydrogen generated, as well as the hydrogen generation lasting time, can be increased.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates the basic operational principle of a typical fuel cell.

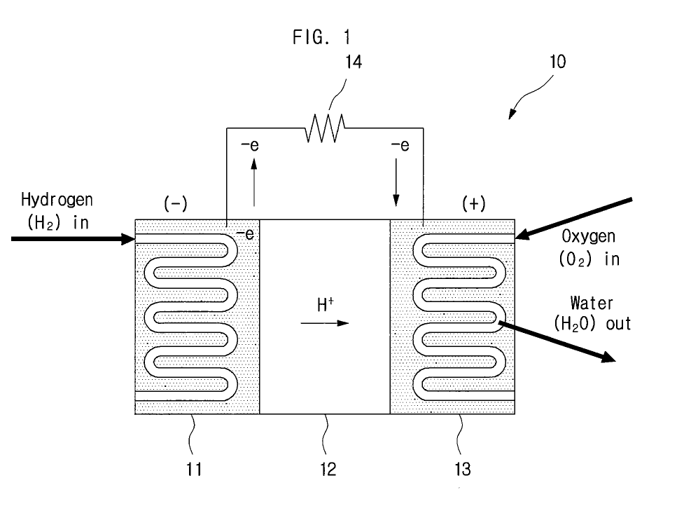

FIG. 2 is a schematic cross-sectional view of a hydrogen generating apparatus according to an embodiment of the present invention.

FIG. 3 is a schematic cross-sectional view of a hydrogen generating apparatus according to another embodiment of the present invention.

### DETAILED DESCRIPTION

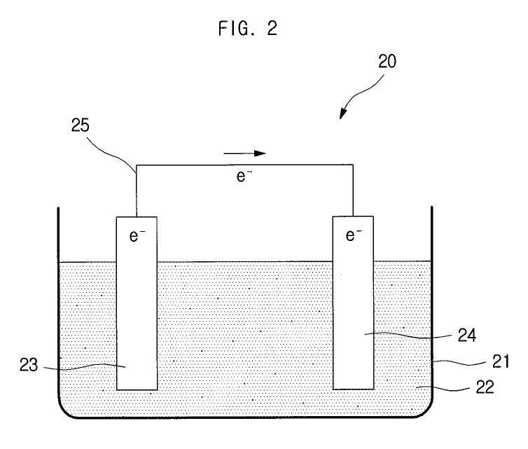

FIG. 2 is a schematic cross-sectional view of a hydrogen generating apparatus according to an embodiment of the present invention. The hydrogen generating apparatus 20 according to this embodiment may be composed of an electrolyzer 21, a first metal electrode 23, and a second metal electrode 24.

For better understanding and easier explanations, the following description will focus on a configuration in which the first metal electrode 23 is made of magnesium (Mg) and the second metal electrode 24 is made of stainless steel.

Referring again to FIG. 2, the electrolyzer 21 contains an electrolyte solution 22 inside. Also inside the electrolyzer 21 are the first metal electrode 23 and the second metal electrode 24. The first and second metal electrodes 23, 24 may be dipped completely or partially in the electrolyte solution.

The first metal electrode 23 is an active electrode, and due to the difference in ionization energy between the magnesium (Mg) electrode and water (H₂O), the magnesium electrode releases electrons (e⁻) into the water and becomes oxidized into magnesium ions (Mg²⁺). The electrons generated here move through a cable 25 to the second electrode 24.

The second metal electrode 24 is an inactive electrode. At the second metal electrode 24, the water receives the electrons that have traveled from the first metal electrode 23 to be dissociated into hydrogen molecules.

The following Reaction Scheme 2 represents the chemical reactions described above:

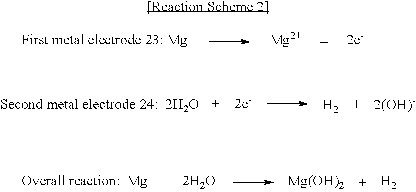

The electrolyte solution according to an aspect of the invention contains one or more metal borohydride as a reducing agent. Because of the oxidation-reduction potential between the first metal electrode and the second metal electrode, the releasing of hydrogen from the borohydride may be facilitated. To be more specific, as the borohydride reacts with water to yield hydrogen and a borate ion, the amount of hydrogen generated may be increased. This represented as a chemical reaction is as shown in the following Reaction Scheme 3:

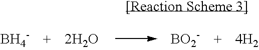

The metal borohydride may be selected from the group consisting of lithium borohydride (LiBH₄), sodium borohydride (NaBH₄), potassium borohydride (KBH₄), ammonium borohydride (NH₄BH₄), tetramethyl ammonium borohydride ((CH₃)₄N(BH₄)), and mixtures thereof, but is not thus limited.

The concentration of the metal borohydride may be about 5 to about 50 weight % based on the total weight of the electrolyte solution. If the concentration of the metal borohydride is less than 5 weight %, the effect on the amount of hydrogen generation is too little, so that there is no significant effect of adding the metal borohydride. On the other hand, if the concentration is greater than 50 weight %, although the amount of hydrogen generation can be increased, it may be difficult to reduce the reaction rate and regulate the flow rate of hydrogen.

An electrolyte solution made only with water and borohydrides provides low ion conductivity and slow chemical dissociation reaction rate under electrochemical reaction conditions, so that consequently, the rate of hydrogen generation may also be slow. Also, as time passes for the hydrogen generating reaction, the concentration of borohydrides in the solution may gradually decrease, whereby a sufficient flow rate of hydrogen may not be available. If the hydrogen is not obtained in the sufficient flow rate, the first metal electrode would scarcely be used up. Also, when the hydrogen generating reaction is in progress, the flow rate of hydrogen may rapidly increase, so that there may be overflowing of the water inside the electrolyzer. Thus, in an electrochemical reaction system using metal electrodes, it may be advantageous to regulate the rate of the hydrogen generating reaction.

Furthermore, the borates which are produced as a result of the reaction (e.g. sodium borate obtained after using sodium borohydride) do not readily dissolve in water. Another byproduct, the metal hydroxides (e.g. magnesium hydroxide (Mg(OH)₂), etc.) also have a solubility of only about 12 mg/L with respect to water. Thus, if the reaction is continued for long periods of time, the magnesium hydroxide (Mg(OH)₂) or sodium borate exist inside the electrolyzer in the form of a slurry, which absorbs water. The water absorbed by the magnesium hydroxide or sodium borate may be prevented from participating in the electrochemical/chemical reaction. Also, the magnesium hydroxide or sodium borate may exist as a slurry between the first metal electrode and second metal electrode, such that the reaction area for generating hydrogen may be reduced.

An electrolyte solution for a hydrogen generating apparatus according to an embodiment of the invention may include at least one or more ionic compound and/or at least one or more chelating agent, in order to not only obtain a sufficient hydrogen flow rate and regulate the reaction rate of hydrogen generation, but also partially or completely dissolve byproducts of the reaction such as the magnesium hydroxide or borates.

The ionic compound included in the electrolyte solution increases the conductivity of the electrolyte solution and facilitates the hydrolysis reaction for the borohydride. Therefore, the electrolyte solution including the ionic compound and borohydride has the advantage of shorter induction time for generating hydrogen, compared to the electrolyte solution including only the borohydride.

Examples of ionic compounds that can be used in embodiments of the invention include, but are not limited to, lithium chloride, potassium chloride, sodium chloride, calcium chloride, potassium nitrate, sodium nitrate, potassium sulfate, sodium sulfate, and mixtures thereof. Potassium chloride may be especially advantageous in certain embodiments of the invention.

The concentration of the ionic compound may be about 5 to about 35 weight % based on the total weight of the electrolyte solution, and may advantageously be set within a range of 10 to 30 weight %. If the concentration of the ionic compound is less than 5 weight %, the conductivity of the electrolyte solution may not be sufficiently increased, whereas if the concentration is greater than 35 weight %, there may be rapid hydrogen generation, or the amount may exceed the solubility to water to remain in a solid state.

To use water sufficiently in a hydrogen generating apparatus according to an aspect of the invention, there may be a need to suppress the generation of solid byproducts or dissolve the generated byproducts partially or completely.

The chelating agent according to this embodiment serves to suppress the occurrence of metal oxides, which are byproducts of the hydrogen generation reaction. To be more specific, the chelating agent bonds with a magnesium ion (Mg²⁺) created at the magnesium electrode, i.e. the first metal electrode 23, to form a water-soluble chelate compound. As the amount of magnesium hydroxide, i.e. a metal hydroxide, generated is reduced due to the reaction of the chelating agent, the efficiency of hydrogen generation is not rapidly decreased.

Examples of the chelating agent in certain embodiments of the invention include carboxylates. Specifically, potassium citrate, sodium citrate, sodium acetate, potassium acetate, ammonium acetate, and mixtures thereof may be used, but the invention is not thus limited.

The following Reaction Scheme 4 represents a reaction in which sodium citrate bonds with a magnesium ion (Mg²⁺) to yield a water-soluble chelate compound.

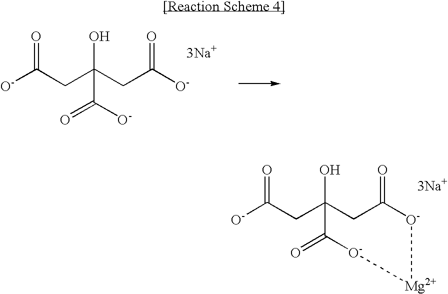

From Reaction Scheme 4 shown above, it is noted that a magnesium ion reacts with sodium citrate to form a water-soluble chelate compound, before being extracted as magnesium hydroxide. Thus, it is observed that the chelating agent, in certain embodiments of the invention, reduces the generation of magnesium hydroxide, which is one of the factors that hinder the generation of hydrogen, and increases the efficiency of water usage, to consequently increase the efficiency of hydrogen generation.

The electrolyte solution in which the water-soluble chelate compound is dissolved has a pH of 7 to 9, so that it is unlikely that the magnesium electrode would be corroded. As such, using the chelating agent may provide the advantages of increased efficiency in generating hydrogen as well as increased stability in hydrogen production.

The concentration of the chelating agent may be about 5 to about 30 weight % based on the total weight of the electrolyte solution, and may advantageously be set within a range of 5 to 15 weight %. If the concentration of the chelating agent is less than 5 weight % or is greater than 30 weight %, there may be reductions in ion mobility.

Also, in certain embodiments of the invention, alcohol may further be added, in order to facilitate the hydrogen generation reaction. The alcohol may serve also to partially or completely dissolve borates, which are reaction byproducts. Specifically, the alcohol may be selected from a group consisting of ethylene glycol, glycerol, methanol, ethanol, butanol, propanol, and mixtures thereof.

The concentration of the alcohol may be about 2.5 to about 15 weight % based on the total weight of the electrolyte solution. This is because with an amount departing from this range, hydrogen may be generated not only by the electrochemical reaction but also by a chemical reaction.

In the case of a hydrogen generating apparatus that does not use the chelating agent and/or the ionic compound, there may be occurrences of the flow rate of hydrogen increasing rapidly such that there is overflowing of the water in the reactor. In certain embodiments of the invention, the chelating agent and/or the ionic compound serve to regulate the rate at which hydrogen is generated.

In certain embodiments of the invention, a stabilizing agent may further be added. In embodiments of the invention, materials may be used that are well known in the field of art as stabilizing agents (e.g. sodium hydroxide, etc.).

A hydrogen generating apparatus according to certain embodiments of the invention is structured to have two different metal electrodes dipped in and connected by an electrolyte solution containing a metal borohydride, an ionic compound, and a chelating agent. Such a hydrogen generating device according to embodiments of the invention is an apparatus that can generate hydrogen by means of an electrolysis (auto-electrolysis) reaction (electrochemical reaction) of water and a chemical hydrolysis reaction of a borohydride.

One aspect of the invention may provide a hydrogen generating apparatus that includes an electrolyzer that contains an electrolyte solution described above, which includes at least one or more metal borohydride, at least one or more ionic compound, and at least one or more chelating agent. To be more specific, a hydrogen generating apparatus may be provided that includes an electrolyzer, which contains an electrolyte solution of water, at least one metal borohydride, at least one ionic compound, and at least one chelating agent; a first metal electrode, which is positioned inside the electrolyzer and dipped in the electrolyte solution, and which is configured to generate electrons; and a second metal electrode, which is positioned inside the electrolyzer and dipped in the electrolyte solution, and which is configured to receive the electrons to generate hydrogen.

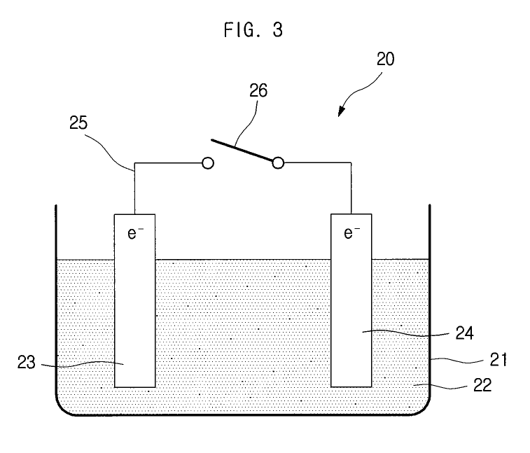

As shown in FIG. 3, the hydrogen generating apparatus may further include a switch 26 positioned between the first electrode 23 and the second electrode 24. If the switch is turned on, the electrons generated at the first electrode 23 are moved to the second electrode 24, and if it is turned off, the electrons generated at the first electrode 23 are made not to move to the second electrode 24. In the case of a hydrogen generating apparatus based on an embodiment of the invention, the induction time for hydrogen generation is short and the amount of hydrogen generated is increased, so that a quick response time may be obtained for the on/off switch.

The first metal electrode 23 may be made of a metal, besides magnesium, that has a relatively strong tendency to become ionized, such as aluminum (Al), zinc (Zn), and iron (Fe), etc. Also, the second metal electrode 24 may be made of a metal, besides stainless steel, that has a relatively weaker tendency to be ionized compared to the metal forming the first metal electrode 23, such as platinum (Pt), copper (Cu), gold (Au), silver (Ag), and iron (Fe), etc.

In certain embodiments of the invention, two or more first metal electrodes 23 and/or second metal electrodes 24 may be installed in the electrolyzer 21. Increasing the number of first metal electrodes 23 and/or second metal electrodes 24 increases the amount of hydrogen generated for the same time, and it is possible to generate a desired amount of hydrogen in a shorter period of time.

In addition, a hydrogen generating apparatus according to an embodiment of the invention may be coupled to a fuel cell to supply hydrogen to the fuel cell. The fuel cell may be, but is not limited to, a polymer electrolyte membrane fuel cell (PEMFC), which can be suitable for a micro fuel cell.

A hydrogen generating apparatus based on certain embodiments of the invention may also be used in a fuel cell system that includes a membrane-electrode assembly (MEA), to which hydrogen is supplied and which coverts the chemical energy of the hydrogen to electrical energy and thus produce a direct current.

The invention may be better understood by referring to the following examples which are intended for illustrative purposes only and are not to be construed in any way as limiting the scope of the present invention, which is defined in the claims appended hereto.

### EXAMPLES

A hydrogen generating apparatus was prepared with the following conditions, which has a hydrogen generation rate of 42 cc/min.

First metal electrode 23: 3 g of magnesium

Second metal electrode 24: stainless steel

Distance between electrodes: 1 mm

Number of electrodes: four magnesium electrodes, four stainless steel electrodes

Electrode connection method: serial connection

Volume of aqueous electrolyte solution: 60 cc

Electrode dimensions: 24 mm×85 mm×1 mm

Potassium chloride, sodium borohydride, sodium citrate, and/or ethylene glycol were added to the hydrogen generating apparatus, according to the following Table 1, and an electrochemical reaction was performed, while a mass flow meter (MFM) was used to confirm the generation of hydrogen and measure the hydrogen generation (42 cc/min) lasting time. The results are also listed in the following Table 1.

TABLE 1

| | | | Comparative | | |
|---|---|---|---|---|---|
| | Example | | Example | | |
| Catagory | 1 | 2 | 1 | 2 | 3 |
| potassium chloride (weight %) | 30 | 30 | 30 | 30 | 30 |
| sodium borohydride (weight %) | 10 | 10 | 10 | — | — |
| sodium citrate (weight %) | 5 | 5 | — | 5 | — |
| sodium hydroxide (weight %) | 1 | 1 | 1 | — | — |
| ethylene glycol (weight %) | — | 2 | — | — | — |
| hydrogen generation | 270 | 280 | 250 | 230 | 210 |
| (42 cc/min) lasting Time (min) | | | | | |

From the results listed in Table 1, it can be seen that the time and amount of hydrogen generation are greater for the electrolyte solutions of Examples 1 and 2, than for the solutions of Comparative Examples 1 to 3. Also, with the electrolyte solutions of Examples 1 and 2, the flow rate of hydrogen does not rapidly increase, so that it is possible to regulate the rate at which the hydrogen is generated and thus produce hydrogen in a stable manner.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. An electrolyte solution for a hydrogen generating apparatus, the electrolyte solution comprising:
water;
a metal borohydride;
an ionic compound; and
a chelating agent.

2. The electrolyte solution of claim 1, wherein the metal borohydride is selected from the group consisting of lithium borohydride, sodium borohydride, potassium borohydride, ammonium borohydride, tetramethyl ammonium borohydride, and mixtures thereof.

3. The electrolyte solution of claim 1, wherein a concentration of the metal borohydride is about 5 to about 50 weight % based on the total weight of the electrolyte solution.

4. The electrolyte solution of claim 1, wherein the ionic compound is selected from the group consisting of lithium chloride, potassium chloride, sodium chloride, calcium chloride, potassium nitrate, sodium nitrate, potassium sulfate, sodium sulfate, and mixtures thereof.

5. The electrolyte solution of claim 1, wherein the concentration of the ionic compound is about 5 to about 35 weight % based on the total weight of the electrolyte solution.

6. The electrolyte solution of claim 1, wherein the chelating agent is a carboxylate.

7. The electrolyte solution of claim 6, wherein the carboxylate is selected from the group consisting of potassium citrate, sodium citrate, sodium acetate, potassium acetate, ammonium acetate, and mixtures thereof.

8. The electrolyte solution of claim 1, wherein the concentration of the chelating agent is about 5 to about 30 weight % based on the total weight of the electrolyte solution.

9. The electrolyte solution of claim 1, further comprising alcohol.

10. The electrolyte solution of claim 9, wherein the alcohol is selected from the group consisting of ethylene glycol, glycerol, methanol, ethanol, butanol, propanol, and mixtures thereof.

11. The electrolyte solution of claim 9, wherein the concentration of the alcohol is about 2.5 to about 15 weight % based on the total weight of the electrolyte solution.

12. A hydrogen generating apparatus comprising:
an electrolyzer containing the electrolyte solution of claim 1;
a first metal electrode positioned inside the electrolyzer and dipped in the electrolyte solution, the first metal electrode configured to generate electrons; and
a second metal electrode positioned inside the electrolyzer and dipped in the electrolyte solution, the second metal electrode configured to receive the electrons and generate hydrogen.

13. The hydrogen generating apparatus of claim 12, further comprising a switch positioned between the first electrode and the second electrode.

14. The hydrogen generating apparatus of claim 12, wherein the first metal electrode is is composed with magnesium.

15. The hydrogen generating apparatus of claim 12, coupled to a fuel cell and configured to supply hydrogen.

16. The hydrogen generating apparatus of claim 12, having two or more of each of the first metal electrode and the second metal electrode are installed in the electrolyzer.

17. A fuel cell system comprising:
the hydrogen generating apparatus of claim 12; and
a membrane-electrode assembly (MEA) configured to receive hydrogen generated by the hydrogen generating apparatus and convert chemical energy of the hydrogen into electrical energy to produce a direct current.
